(19) United States
(12) Patent Application Publication
(10) Pub. No.: US 2024/0296042 A1
(43) Pub. Date: Sep. 5, 2024

(54) ELECTRONIC CONTROL UNIT, VEHICLE WITH ELECTRONIC CONTROL UNIT, AND METHOD FOR UPDATING ELECTRONIC CONTROL UNIT

(71) Applicant: CARIAD SE, Wolfsburg (DE)

(72) Inventor: Adrian NISTOR, Nürnberg (DE)

(21) Appl. No.: 18/575,767

(22) PCT Filed: Jul. 8, 2021
(86) PCT No.: PCT/EP2021/069030

§ 371 Date: Dec. 29, 2023

(51) Int. Cl. G06F 8/654

(52) U.S. Cl. CPC G06F 8/654

(57) ABSTRACT

The disclosure a method for updating an electronic control unit (ECU) with a flash memory. The method includes: receiving a request to download and install a software update package, determining a package size of the software update package and an update counter value based on the package size, incrementing an update counter for an allocated software update memory of the flash memory with the determined update counter value to obtain an incremented update counter, determining if the incremented update counter exceeds an update blocking value, and updating the ECU by downloading and installing the software update package in the allocated software update memory of the flash memory, if the incremented update counter does not exceed the predefined update blocking value.

### BACKGROUND

### Technical Field

The disclosure is concerned with a method for updating an electronic control unit comprising a flash memory, an electronic control unit and a vehicle with an electronic control unit.

### Description of the Related Art

In general, especially for high-performance computing platforms (HCP) electronic control units (ECU), the flash wearing needs to be considered when selecting the flash memory, depending on characteristics like size, maximum number of program/erase cycles, single-level cell mode or multi-level cell mode and others. Also, the design of software systems running on the ECU needs to be considered with regard to how much and when to write in a flash memory.

For ECUs, software updates are one of the important contributors of writing into the flash. Therefore, a specific flash writing limit or rather an update blocking value is set for software updates to prevent writing too much over time in the flash memory that can cause a flash performance degrade or even flash memory getting broken.

Usually, a flash memory of an ECU has an allocated software update memory where software update packages are installed. Given the limited capacity of writing in this area of the software update memory, usually an update counter is increased by a fixed number with each software update until the update counter reaches an update blocking value. After reaching the update blocking value following updates are blocked for this flash memory, to avoid flash wear out of the software update memory. For example, it was previously intended to allow only up to 50 updates until subsequent updates were blocked.

In US 2006/0075284 A1 a method for receiving, storing, and applying an update package to modify an original image stored within non-volatile flash memory devices is disclosed. The method provides a download agent responsible for communicating with a server to transfer and store the update package and an update agent responsible for verifying, decompressing and decoding the update package. The method separates non-essential operating system components and applications from the core operating system, storing the non-essential operating system components, applications, and download agent as a single image in a read-only file system. This image may then be updated by applying an update package created by running a binary differencing engine on two pre-built file system images representing the current and new file systems to modify the stored image.

In DE 10 2010 054 783 A1 a method for storing a file in a portable file system is disclosed, wherein the file comprises a data descriptor and file content, wherein the file is stored in a non-volatile memory area of the data storage.

In US 2004/0088473 A1 a system and method for updating a binary image stored across a block-structured memory device, such as a flash memory device is disclosed.

A disadvantage of previously known methods for updating an ECU comprising a flash memory is, that the software update memory of the flash memory is not efficiently utilized regarding to a maximum possible number of updates.

### BRIEF SUMMARY

Embodiments of the present disclosure provide a method and an ECU with an improved software update method.

A first aspect of the disclosure relates to a method for updating an electronic control unit (ECU) that includes a flash memory, wherein the ECU receives a request to download and install a software update package, determines a package size of the software update package and an update counter value based on the package size, increments an update counter for an allocated software update memory of the flash memory with the update counter value to obtain an incremented update counter, determines, if the incremented update counter exceeds a predefined update blocking value, and updates the ECU by downloading and installing the software update package in the allocated software update memory of the flash memory in response to determining that the incremented update counter does not exceed the predefined update blocking value.

In other words, a size of a software update package to install is determined and an update counter value is adapted to the package size of the software update package to increase the update counter. In particular, the ECU can comprise flash memory, wherein an allocated software update memory within this flash memory is reserved for software update packages to install. The software update memory can comprise a predefined update blocking value, which limits the number of updates of the ECU to prevent writing too much over time in a software update memory.

The update counter value can be calculated by a conversion of the update package size, wherein, for instance, small package sizes can be converted to small update counter values and large package sizes can be converted to large update counter values. Preferably, the update blocking value is preset accordingly, such that the update blocking value may be increased to take account for possible smaller package sizes. After determining, if an incremented update counter is below or above the predefined update blocking value, the ECU can be updated by downloading and installing the software update package. That is, the downloading may comprise transferring the software update package to the ECU from an external server or flashing tool and installing may comprise configuring/compiling the software update package in the software update memory, especially by having an ECU-specific updater/bootloader processing and writing the downloaded update package into the corresponding programming memory (e.g., system partition(s) in Linux/Android), if the incremented update counter is below the update blocking value. If the incremented update counter is above the update blocking value, the update of the ECU can be canceled and a warning notification can be generated.

Preferably, the ECU is a vehicle ECU, especially a high-performance computing platform ECU. The ECU can comprise an algorithm, which is configured to perform the method, wherein the ECU can comprise a transceiver unit, which is configured to receive the request to download and install the software update package and after the determination that the incremented update counter does not exceed the predefined blocking value to download the software update package in the software update memory. The allocated software update memory can have a writing budget that refers to how much programming memory is allowed to be written throughout the life cycle of the ECU, such as to avoid the flash wear out process. The other part of the flash memory can be reserved for other factors or components of the ECU.

One advantage of the disclosure is that the flash memory is used more efficiently because the maximum number of updates is adapted more precisely to the package size of the software update and hence be utilized more efficiently when comparing the maximum allowed number of software updates relative to the maximum allowed writing budget.

The disclosure also comprises embodiments that provide features which afford additional technical advantages.

In one embodiment, the update counter value is determined from a look-up-table, wherein the look-up-table provides a plurality of predefined package size ranges, and wherein each package size range is assigned to an update counter value. In other words, the package size of a software update package is compared to a matching entry in a look-up table, and the update counter value is derived from that matching entry. Especially, predefined package size ranges can be provided in the look-up table, which are assigned to a corresponding update counter value so that the package size can be assigned to the corresponding update counter value. The predefined package size ranges can, for example, comprise steps of 100 MB so that a first package size range is from 0 to 100 MB, a second from 100 to 200 MB and so on. This embodiment provides a fast and easy way to determine the update counter value.

Preferably, the update blocking value is calculated by a writing budget of the software update memory divided through a maximum value of the smallest package size range. That is, the maximum possible number of updates indicated by the update blocking value, is determined by the number of the smallest package sizes that fit into the software update memory. For example, a maximum value of the smallest package size range is 100 MB and the writing budget of a software update memory may be 125 GB. Then, the maximum number of possible updates with the smallest package size range and thus the update blocking value would be 1250. As mentioned above the writing budget is a predetermined value that indicates the allowed amount of data to be written throughout the life cycle of the flash memory before a flash wear out is expected.

Particularly advantageous, the update counter value for each package size range is calculated by the respective maximum value of each package size range divided through a maximum value of the smallest package size range. In other words, it is calculated how many of the smallest package size ranges equals a respective package size range, and this number is used as the update counter for the respective package size range. For example, the first package size ranges from 0 to 100 MB and the second package size range ranges from 100 to 200 MB. So, the update counter for the first range equals 1, and the update counter for the second range equals 2. Preferably, in the case of fractions, the numbers are rounded down to guarantee that the writing budget is not exceeded. These embodiments can realize an advantageous implementation of a look-up table that is reliable and accurate.

In another embodiment, the update of the ECU is canceled and a warning signal is generated, if the incremented update counter exceeds the update blocking value. Preferably, a warning signal is used to trigger a warning notification on a display device connected to the ECU. For example, an ECU can be implemented in a motor vehicle, and the display device of the motor vehicle, especially from an infotainment system, may display the warning notification, if the update counter exceeds the update blocking value. This embodiment provides the advantage that the software update package cannot exceed the writing budget of the software update memory and ensures correct installation of the respective software update. Furthermore, a user can be warned that the flash memory and/or the ECU has to be changed. Therefore, a safe operation of the ECU can be maintained.

In another embodiment, the update counter is also increased and/or the update blocking value is decreased by the determined update counter value, if the update of the ECU fails. In other words, the update of the ECU can fail or partially fail for different reasons, for example, a disconnection, a software error or a power failure. Nevertheless, in this case the update counter is also increased by the determined update counter value for safety reasons. In particular, it cannot be excluded that a part of a software update had been written in the software update memory. To not unintentionally exceed the writing budget of the software update memory, the update counter is incremented with the determined update counter value. Alternatively or additionally, the update blocking value can be reduced, wherein in the event that both are adapted, the adaptation can take place on a proportional basis. This embodiment provides the advantage that a safety of the ECU can be increased.

In another embodiment, a difference between a present ECU software version and an updated ECU software version to achieve is determined, wherein the software update package contains a delta update with a determined difference. This is, only the differences of a code that has changed and not the whole program of the software version is downloaded. For example, the present ECU software version is 200 MB, and the updated ECU software version to achieve is 205 MB, that adds in additional 5 MB to the software size. Then only this 5 MB will be downloaded instead of the full version. The advantage of this embodiment is that the ECU can be updated faster and more efficiently. Furthermore, the advantages of the proposed method for updating the electronic control unit are further enhanced.

In another embodiment, the ECU comprises a protected testing routine, wherein the update blocking value is disabled or manually set in the testing routine. In other words, the protected testing routine allows a setting of the update blocking value to a high value for development and testing purposes, e.g., automatic flash tests. This testing routine is preferably accessed only with a super user role by an authorized user. This gives the advantage, that testing with the ECU is more feasible.

A further aspect of the disclosure relates to an electronic control unit (ECU) with a flash memory, wherein the ECU is configured to perform the method according to any one of the preceding embodiments. In this aspect, the same advantages and variations arise as with the method.

Another aspect of the disclosure relates to a vehicle with an electronic control unit (ECU) according to the previous aspect of the disclosure. The inventive vehicle is preferably designed as a motor vehicle, in particular as a passenger vehicle or a truck, or as a bus or a motorcycle.

The disclosure also comprises embodiments of the inventive electronic control unit that comprise features that correspond to features as they have already been described in connection with the embodiments of the inventive method. For this reason, the corresponding features of the embodiments of the inventive electronic control unit are not described here again.

The disclosure also comprises a control device for the motor vehicle. The control device may comprise a data processing device or a processor circuit adapted to perform an embodiment of the method according to the disclosure. For this purpose, the processor circuit may comprise at least one microprocessor and/or at least one microcontroller and/or at least one FPGA (field programmable gate array) and/or at least one DSP (digital signal processor). Furthermore, the processor circuit may comprise program code which comprises computer-readable instructions to perform the embodiment of the method according to the disclosure when executed by the processor device. The program code may be stored in a data memory of the processor device.

The disclosure also comprises the combinations of the features of the different embodiments.

### BRIEF DESCRIPTION OF THE SEVERAL VIEWS OF THE DRAWINGS

In the following an exemplary implementation of the disclosure is described.

FIG. 1 shows a schematic illustration of an embodiment of the inventive motor vehicle;

FIG. 2 shows a schematic illustration of a process diagram;

FIG. 3 shows an exemplary illustration of a look-up table; and

FIG. 4 shows a graph showing a comparison between fixed and adaptive update counter values.

### DETAILED DESCRIPTION

The embodiment explained in the following is an advantageous embodiment of the disclosure. However, in the embodiment, the described components of the embodiment each represent individual features of the disclosure which are to be considered independently of each other and which each develop the disclosure also independently of each other and thereby are also to be regarded as a component of the disclosure in individual manner or in another than the shown combination. Furthermore, the described embodiment can also be supplemented by further features of the disclosure already described.

In the figures identical reference signs indicate elements that provide the same function.

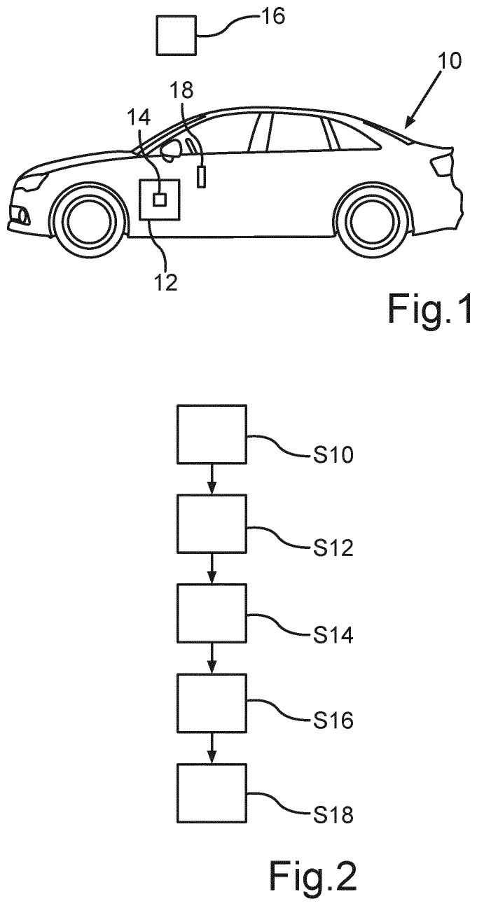

FIG. 1 shows a schematic motor vehicle 10 with an electronic control unit 12 (ECU) according to an exemplary embodiment. In particular, the ECU 12 can be a high-performance computing platform, for example, for autonomous driving of the vehicle 10. The ECU 12 may comprise a flash memory 14 for ECU software, wherein the flash memory 14 may also comprise an allocated update memory that is reserved for software update packages to be installed for the ECU 12.

In particular, several updates may be provided over time to be downloaded and installed on the ECU 12 to customize features or install new features. However, the software update memory of the flash memory 14 has only a limited writing budged before a flash wear out can occur. To maximize the number of updates and prevent an exceeding of this writing budget, the ECU 12 may perform the method shown in FIG. 2.

In a step S10, the ECU 12 can receive a request to download and install a software update package, for example, from a server 16. Alternatively, the software update package can be provided by a flash tool (not shown) that may be collocated with the vehicle 10 or device in a service workshop or lab. The server 16 may be a server in the internet that is configured to provide software updates for the vehicle 10 and/or the ECU 12. Preferably, the server 16 can send a request to download and install the software update package by means of Wi-Fi, Bluetooth and/or a mobile communication standard.

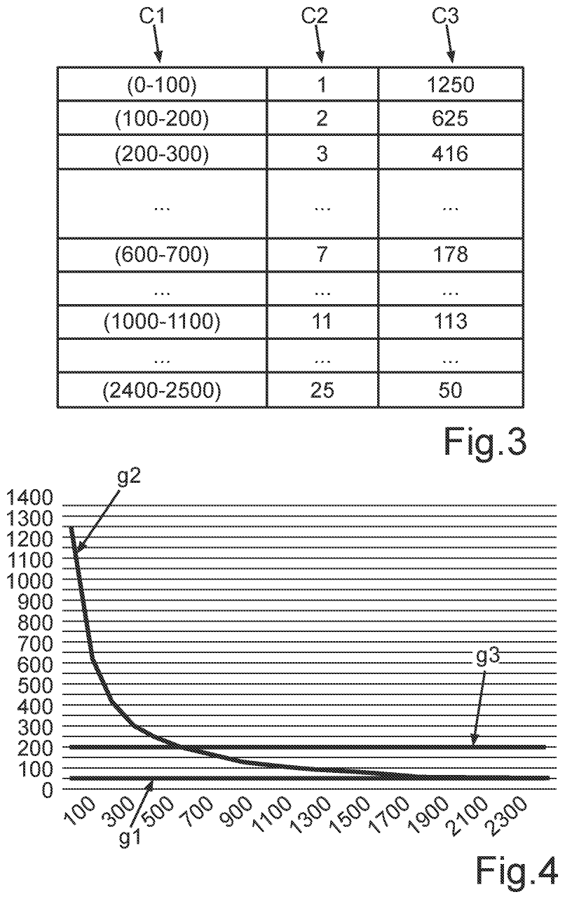

After receiving the request, the ECU 12 determines the package size of the software update package in a step S12. Furthermore, the ECU 12 determines an update counter value in dependence of the package size, wherein the update counter value may be derived from a look-up table. The look-up table can comprise a plurality of predefined package size ranges associated with corresponding update counter values. For example, FIG. 3 shows an exemplary look-up table, wherein in column C1 package size ranges for different package sizes are assigned to corresponding update counter values in column C2. In column C3, the corresponding maximum number of updates that are possible for each package size are shown, assuming that the writing budget of the software update memory is 125 GB.

In a step S14, an update counter for the allocated software update memory can be incremented with the determined update counter value. For example, the package size of the software update package is 250 MB resulting in the update counter value of 3 according to the exemplary look-up table in FIG. 3 with which the update counter is increased.

In the following step S16 it is determined, whether the incremented update counter exceeds the predefined update blocking value. The update blocking value is preferably dependent on the writing budget of the software update memory. In particular, the update blocking value may be calculated by the writing budget of the software update memory divided through a maximum value of the smallest package size range. Referring to FIG. 3, this would mean, the update blocking value equals 1250.

Finally, in a step S18, the ECU 12 is updated by downloading and installing the software update package in the allocated software update memory of the flash memory 14, if the incremented update counter is below the predefined update blocking value. In other words the software update package is downloaded from server 16 into the flash memory 14 and then configured by the ECU 12.

Preferably, before receiving the request to download and install the software update in Step S10, a difference between the present ECU software version and an ECU software version to achieve is checked, and only a delta update with the difference is then requested to be installed in the flash memory 14 as software update package. This gives the advantage that smaller package sizes can be used for updates and therefore more updates can be installed before the update blocking value is reached.

In case the determination in step S16 results that the update blocking value is reached by the incremented update counter, the update can be canceled, and a warning signal can be generated by the ECU 12. The warning signal can be used to trigger a warning notification on a display device 18 of the vehicle 10 to notify a user that the blocking value is reached, and a car service has to be performed. Additionally or alternatively the warning signal can be used to trigger a warning notification on a Backend/IT infrastructure, especially the server 16, and/or the flash tool.

Furthermore, it is advantageous to increment the update counter for the allocated software update memory, even if the update of the ECU 12 fails or partially fails to ensure that the writing budget of the software update memory is not exceeded because parts of the failed update can still remain in the software update memory. Another possibility is that the update blocking value is reduced accordingly or both values are changed proportionally.

FIG. 4 shows an exemplary comparison between a classical solution with a fixed update counter value to the method shown with adaptive update counter values. The y-axis depicts a possible number of updates with a given software update memory, and the x-axis depicts different update sizes of software update packages. The graph g1 shows the classical solution, wherein the update blocking value may be set to 50 to handle multiple updates with maximum size (compare FIG. 3). The graph g2 shows the adaptive update counter that is incremented in dependence of the package size of the software update. Especially for smaller update package sizes, it can be seen that the maximum number of possible updates is highly increased with the proposed method. In particular, graph g3 shows the average number of possible updates that can be performed with the proposed method. It can be seen that the average number of updates can be increased by a factor of four compared to the classical solution shown by graph g1.

Overall, the examples show how an adaptive program counter increment for software updates can be provided.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method performed by an electronic control unit, ECU, that includes a flash memory, the method comprising:
receiving a request to download and install a software update package;
determining a package size of the software update package and an update counter value based on the package size;
incrementing an update counter for an allocated software update memory of the flash memory with the update counter value to obtain an incremented update counter;
determining if the incremented update counter exceeds an update blocking value; and
updating the ECU by downloading and installing the software update package in the allocated software update memory of the flash memory, in response to determining that the incremented update counter does not exceed the update blocking value.

2. The method according to claim 1, wherein the update counter value is determined from a look-up-table, wherein the look-up-table provides a plurality of package size ranges, and wherein each of the package size ranges is associated with a corresponding one of a plurality of update counter values.

3. The method according to claim 2, wherein the update blocking value is calculated by a writing budget of the allocated software update memory divided by a maximum value of a smallest one of the plurality of package size ranges.

4. The method according to claim 2, wherein the corresponding one of the plurality of update counter values for each of the plurality of package size ranges is calculated by a respective maximum value of each of the plurality of package size ranges divided by a maximum value of a smallest one of the plurality of package size ranges.

5. The method according to claim 1, further comprising:
generating a warning signal in response to determining that the incremented update counter exceeds the update blocking value.

6. The method according to claim 1, wherein the update counter is increased and/or the update blocking value is decreased by the update counter value, if the updating of the ECU fails.

7. The method according to claim 1, determining a difference between a present ECU software version and an updated ECU software version, wherein the software update package contains a delta update with the difference between the present ECU software version and the updated ECU software version.

8. The method according to claim 1, wherein the ECU includes a protected testing routine, and wherein the update blocking value is disabled or manually set in the protected testing routine.

9. An electronic control unit, ECU, comprising:
a processor; and
a flash memory storing instructions that, when executed by the processor, cause the ECU to:
receive a request to download and install a software update package;
determine a package size of the software update package and an update counter value based on the package size;
increment an update counter for an allocated software update memory of the flash memory with the update counter value to obtain an incremented update counter;
determine if the incremented update counter exceeds an update blocking value; and
update the ECU by downloading and installing the software update package in the allocated software update memory of the flash memory, in response to determining that the incremented update counter does not exceed the update blocking value.

10. A vehicle with an electronic control unit, ECU, according to claim 9.
